(19) United States
(12) Patent Application Publication
(10) Pub. No.: US 2016/0079828 A1
(43) Pub. Date: Mar. 17, 2016

(54) BEARING ARRANGEMENT IN AN ELECTRIC MOTOR

(71) Applicant: Schaeffler Technologies AG & Co. KG, Herzogenaurach (DE)

(72) Inventors: Friedrich Schuler, Wilhelmsdorf (DE); Stefan Lintner, Oberasbach (DE); Jens Schaefer, Herzogenaurach (DE)

(21) Appl. No.: 14/785,701

(22) PCT Filed: Jun. 24, 2014
(86) PCT No.: PCT/DE2014/200279

§ 371 Date: Oct. 20, 2015

(30) Foreign Application Priority Data
Jul. 3, 2013 (DE) 10 2013 212 933.5

(51) Int. Cl. H02K 7/08; F16C 19/54; F16C 35/063; H02K 5/08; H02K 5/173

(52) U.S. Cl. CPC H02K 7/083; H02K 5/08; H02K 5/1732; F16C 35/063; F16C 19/54

(57) ABSTRACT

A bearing arrangement in an actuating motor of an electrical camshaft adjuster, including: a first, bowl-shaped housing part made of metal; a second housing part made of plastic, closing off the first housing part; a first roller bearing which is held in the first housing part; a second roller bearing which is inserted into the second housing part; and a shaft mounted by means of the first and second roller bearings. The first roller bearings is designed as a fixed bearing. A contact surface which transmits force, and which is smaller than the inner running surface of an inner ring of the first roller bearing, is formed between the shaft and the inner ring. The first roller bearing is designed as an open bearing which is lubricated by an operating medium. The second roller bearing is designed as a sealed bearing with a lifetime supply of grease.

### CROSS-REFERENCE TO RELATED APPLICATIONS

The present application is the U.S. national stage application pursuant to 35 U.S.C. §371 of International Application No. PCT/DE2014/200279, filed Jun. 24, 2014, which application claims priority of German Application No. 10 2013 212 933.5, filed Jul. 3, 2013.

### TECHNICAL FIELD

The present disclosure describes a bearing arrangement in an electric motor, having two roller bearings. At least one housing part of the electric motor is made of plastic.

### BACKGROUND

A bearing arrangement in the class is disclosed by way of example in DE 10 2011 080 265 A1. This is a bearing arrangement which is used in an electric motor of an electrical camshaft adjuster. The electric motor has a housing which is composed of plastic and metal parts.

An electric motor which has housing parts—specifically bearing shields—made of plastic is known from DE 10 2005 051 245 A1, by way of example. A roller bearing used to mount the shaft of the electric motor is held in each of two bearing shields—a front and a rear. The electric motor can be a component of an electrical power tool.

A further electric motor having at least one housing part made of plastic is known from EP 0 176 839 A1, for example. A bearing seat for the purpose of mounting a rotor shaft is sprayed onto a motor housing in this case. The bearing itself is designed as a plain bearing.

An electric motor having a bearing made partially as a roller bearing and partially as a plain bearing is known from DE 195 24 953 A1, by way of example. This electric motor also has a housing made of plastic.

The use of an electric motor in a camshaft adjuster in an internal combustion engine is known from DE 10 2004 062 037 A1, by way of example. The electric motor in this case functions as an actuating drive of an adjustment mechanism which is designed as a three-shaft transmission.

A further electric motor which functions as an actuating motor of a camshaft adjuster is known by way of example from U.S. Pat. No. 8,220,426 B2. The rotor of this electric motor is mounted by means of two roller bearings—specifically ball bearings.

In the case of roller bearings, the connections between the inner ring and the shaft can be designed in various ways, and full-surface contact between the inner ring of the bearing and the mounted shaft is not necessarily the case. Bearings with only partial contact between the bearing ring and the shaft are known, by way of example, from U.S. Pat. No. 4,792,244 A and DD 93065 A1.

### SUMMARY

The problem addressed by the present disclosure is that of providing a bearing arrangement of an electric motor which is suitable particularly for an electric camshaft adjuster, characterized by a particularly good relationship between the complexity of manufacturing thereof and the reproducibility of operating parameters, particularly the loads placed on bearings, compared to the named prior art.

The bearing arrangement included in the present disclosure has two roller bearings—for example, ball bearings—and serves the purpose of mounting a shaft in an electric motor. The electric motor is, in an example embodiment, an actuating motor of an electrical camshaft adjuster of an internal combustion engine. The electric motor is designed, by way of example, as a brushless, electronically commutated motor.

The housing of the electric motor, which accommodates both of the roller bearings, is composed of a first, bowl-shaped housing part made of metal, and a second housing part connected to the first and made of plastic. In an example embodiment, the electric motor is designed as an internal rotor motor. In an example embodiment, the electric motor is constructed as an external rotor motor. In this latter case, the two housing parts made of metal and/or plastic are rotating components of the electric motor.

In each case, one of the roller bearings is designed as a fixed bearing, and the other roller bearing is a floating bearing. A contact surface which transmits force is formed between the inner ring of the roller bearing, the same functioning as a fixed bearing, and the shaft. According to the present disclosure, this contact surface is smaller than an inner ring which is press-fitted onto a cylindrical shaft. The force-transmitting contact surface is therefore smaller than the inner running surface of the inner ring, and also smaller than the surface section of the running surface of the shaft lying radially inside of this running surface.

It is possible to achieve this reduction of the contact surface compared to the conventional bearing arrangement by, firstly, the fact that the shaft has a smaller diameter in a portion of the region in which it is surrounded by the inner ring of the roller bearing, and therefore does not contribute to the transmission of force between the shaft and the inner ring in this sub-section. This sub-section of the shaft which is deliberately not used as a contact surface is, for example, designed in this case as a groove—also called a waist—in which the inner ring projects into the same from both sides. The inner ring is therefore only pressed onto the shaft in the region of its end faces. In contrast, in the central region of the inner ring, in which the rolling elements roll, no direct radial force is applied by the shaft to the inner ring. Therefore, compared to solutions in the prior art, the expansion of the inner ring resulting from the press-fitting onto the shaft is minimized. This measure also minimizes any changes to the bearing geometry, particularly the play thereof.

In an example embodiment, the reduction of the contact surface between the shaft and the inner ring of the roller bearing compared to the conventional bearing arrangements is realized by embossments on the shaft—particularly bars which provide contact surfaces. In each case, the total contact surface formed between the inner ring and the shaft is advantageously not greater than 60%, particularly not greater than 50% of the inner running surface of the inner ring. This means the surface which would be available as a contact surface if the shaft were a constant cylinder.

In an example embodiment, the roller bearing which functions as a fixed bearing is held either in a housing part made of plastic or a housing part made of metal. In the latter case, the outer ring of the roller bearing included as a fixed bearing is pressed into a receiver section of the housing part made of metal, by way of example. The receiver section in this case constitutes the radially inner limit of an end-face wall of the housing part made of metal, and can have a cylindrical, slightly conical, or stepped shape. In an example embodiment the substantially sleeve-like receiver section of the housing part made of metal has a polygonal shape.

In each case, the geometry of the outer ring and of the receiver section in the preferred design ensures that the outer ring is at most minimally deformed when inserted into the housing. In this case, there can even be a minimal play of the outer ring in the housing part. In an example embodiment, as soon as the outer ring reaches the final position during installation, it is fixed by caulking A small number of embossments are needed in this case. This approach ensures that, on the outer ring as well during the assembly of the bearing arrangement, no forces are applied which would lead to a significant change in the geometric parameters of the roller bearing—that is, to a change in the play in the bearing.

In an example embodiment, the output of the shaft is arranged on the end face of the housing part made of metal. The roller bearing positioned on this end, for example, functioning as a fixed bearing, is not sealed. A shaft seal is, for example, positioned on the side of this roller bearing which faces the internal space of the housing. In contrast to the roller bearing accommodated in the housing part made of metal, the second roller bearing inserted in the housing part made of plastic—for example by injection into the same—is a roller bearing which is sealed on both ends thereof. As such, the first roller bearing is designed as an open bearing which is lubricated by an operating medium, particularly oil, and the second roller bearing is designed as a sealed bearing with a lifetime supply of grease.

In an example embodiment, the housing of the electric motor as a whole is connected to an adjacent component by means of fastening elements attached to the housing part made of metal—for example by bolting.

The advantage of the invention is particularly that a shaft, as well as two roller bearings which mount the shaft, are fixed in the housing of an electric motor in a compact and economical arrangement, which can simultaneously be produced with tight manufacturing tolerances, without additional installed components such as retaining rings. Each of the roller bearings has a bearing play which does not change significantly during the assembly of the bearing arrangement. At the same time, the bearing arrangement reliably transmits all torques and forces which arise.

### BRIEF DESCRIPTION OF THE DRAWINGS

An example embodiment of invention bearing arrangement in an electric motor is described below in further detail with reference to drawings, wherein:

FIG. 1 shows an electric motor in an exploded view,

FIG. 2 shows a top view of the input side of the electric motor according to FIG. 1,

FIG. 3 shows the electric motor in a cutaway view (along the line “A-A” in FIG. 2),

FIG. 4 shows a detail “X” (in FIG. 3), specifically a first roller bearing of the electric motor, and

FIG. 5 shows a detail “Y” (in FIG. 3), specifically of a second roller bearing of the electric motor.

### DETAILED DESCRIPTION

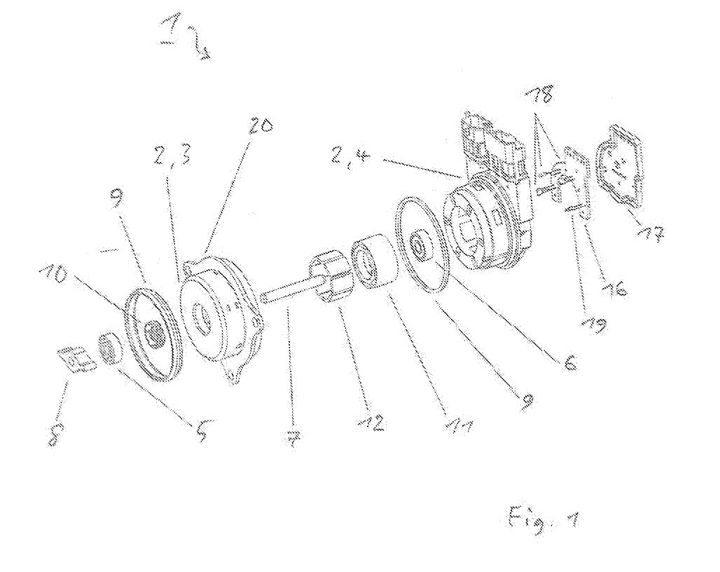

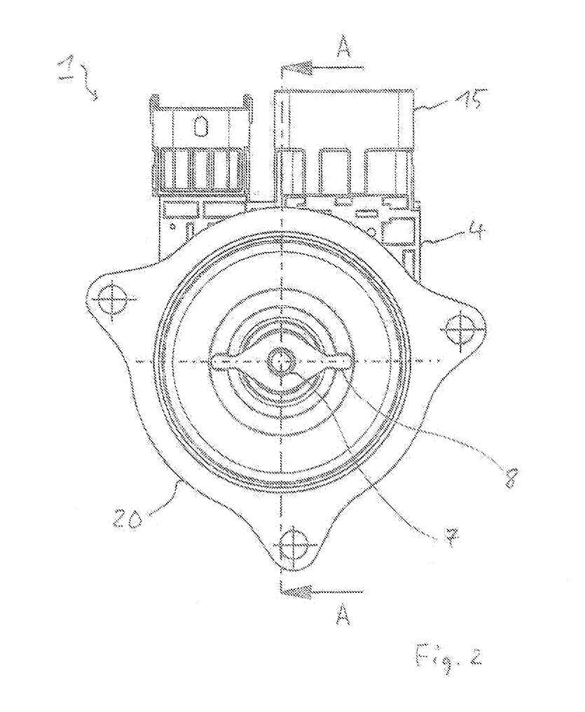

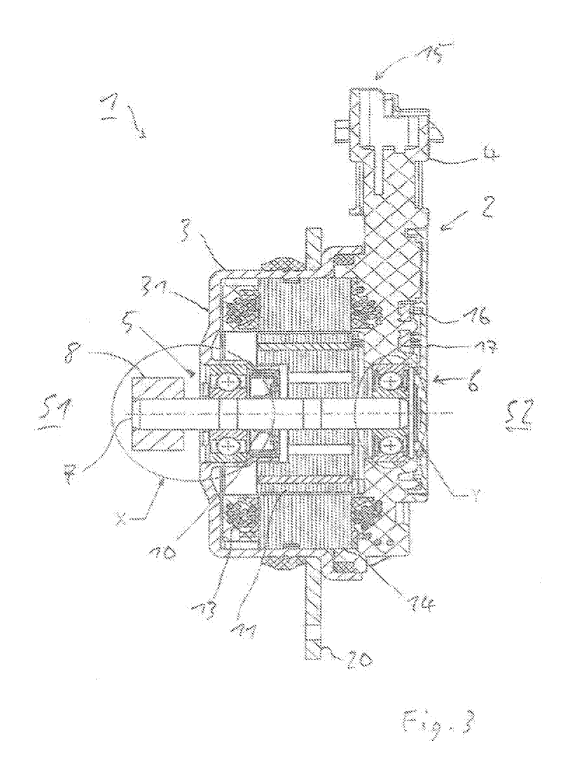

FIGS. 1 to 5 together show an electric motor, indicated by the reference number 1—for example, an electronically commutated motor which is part of a camshaft adjuster, which is not illustrated—of an internal combustion engine. For the basic functionality of such a camshaft adjuster, attention is hereby directed by way of example to the documents DE 10 2004 062 037 A1 and U.S. Pat. No. 8,220,426 B2, noted above.

Electric motor 1 has housing 2 which is composed of two housing parts 3, 4, particularly bowl-shaped housing part 3 made of metal, and housing part 4 made of plastic. Shaft 7 is mounted in housing 2 by means of roller bearing 5 and roller bearing 6. As is explained in further detail below, roller bearing 5 is accommodated in this case in housing part 3, and roller bearing 6 is accommodated in housing part 4. Both roller bearings 5, 6 are designed as ball bearings.

Shaft 7 protrudes from housing 2 (more precisely: from the housing part 3) by end face S1 thereof, and is connected at that location to drive element 8 in a torque-proof manner. A regulating shaft or control disk of a three-shaft transmission, which is not illustrated—by way of example a strain wave gearing, a wobble plate mechanism, a cycloidal drive or a planetary gearing—is adjusted by drive element 8, serving the purpose of shifting the phase of a camshaft relative to a crankshaft of an internal combustion engine. As long as the phase relation between the camshaft and the crankshaft is not changed, drive element 8 and shaft 7 rotate at the rotation speed of the camshaft. The three-shaft transmission actuated by electric motor 1 has a high gear ratio. A rotation of drive element 8 by a certain angle relative to the camshaft therefore leads to a change in the phase relation between the crankshaft and the camshaft by a much smaller angle.

Electric motor 1 is sealed with respect to the internal space of housing 2 by shaft seal ring 10. Shaft seal ring 10 in this case is located in a space-saving manner on the side of roller bearing 5 which faces the internal space of housing 2. Rotor 11 which is fixed to shaft 7 is also positioned in the internal space of housing 2, and carries permanent magnets 12. Electric motor 1 is designed as a synchronous motor excited by permanent magnets. Stator windings 13 which interact with permanent magnets 12 are fixed to housing part 4 made of plastic. Likewise, associated stator laminations 14 are accommodated in housing part 4—for example, injected into the same. Housing part 4 has plugs 15 for the necessary electrical contact.

Circuit board 16 is inserted into housing part 4 toward end face S2 of electric motor 1 which faces away from metallic housing part 3, and is closed with lid 17. Magnetic field sensors 18, which are used to detect the angular position of shaft 7, as well as temperature sensor 19, are positioned on circuit board 16. Electric motor 1 is attached to an adjacent component (not pictured)—for example a cylinder head—by means of housing flange 20 which is located on housing part 3, and seal 9 which surrounds housing part 3 lies flush with housing flange 20 and the cylinder head. Housing part 4, in contrast, is not directly mechanically connected to an adjacent component.

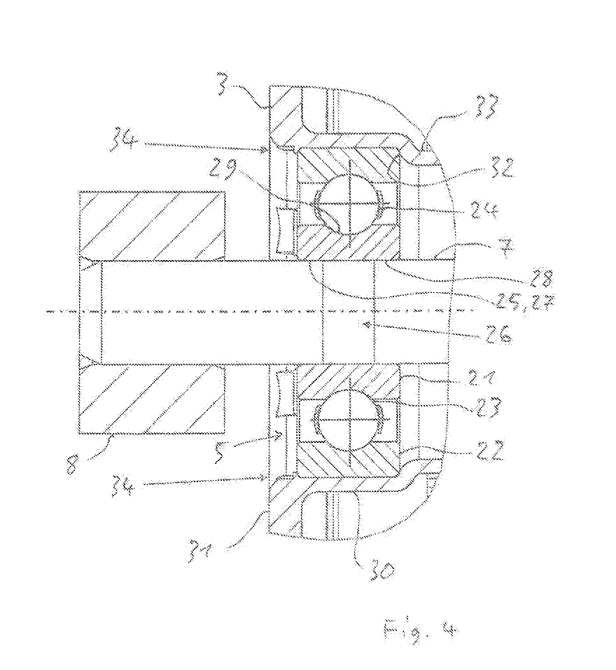

Roller bearing 5, as a fixed bearing, and roller bearing 6, as a floating bearing, are included inside the bearing arrangement which comprises roller bearings 5, 6. The following also refers to FIG. 4 with respect to the connection of roller bearing 5 to shaft 7 as well as the installation of roller bearing 5 into housing part 3.

Roller bearing 5 has, as conventionally known, inner ring 21 and outer ring 22, with rolling elements 23, for example balls, rolling between the same. Balls 23 are guided by cage 24 Inner ring 21 is held on shaft 7 by a press fit by contact surface 25 which is reduced compared to conventional arrangements. To reduce contact surface 25, shaft 7 has waist 26 which is positioned centrally between the end faces of inner ring 21. Contact surface 25 is therefore solely composed of section 27 and section 28, wherein sections 27, 28—both with an annular shape—of contact surface 25 together include at most half of the width of inner ring 21, and exclude the central region of inner ring 21 in which is found running surface 29 for rolling elements 23. In this way, radial force is only transmitted between shaft 7 and inner ring 21 axially by the regions which are distant from running surface 29—specifically via sections 27, 28 of contact surface 25.

Outer ring 22 of roller bearing 5 is held in sleeve-like receiver section 30 which connects as a part of housing part 3 to wall 31 of housing part 3, said wall lying on end face 51 and substantially having the shape of a disk. Facing the internal space of housing 2, receiver section 30 has shoulder 32 oriented radially inward. Outer ring 22 lies thereon and is therefore supported in the axial direction. Proceeding from shoulder 32, receiver section 30 continues in the form of narrowed sleeve section 33 in which shaft seal ring 10 is held.

Outer ring 22 is inserted into receiver section 30 with only a minimal press fit, or even with some play. In order to prevent rotation of outer ring 22, as well as displacement of the same outward in the axial direction, arresting points 34 are formed at the transition between wall 31 and receiver section 30, which fix outer ring 22 in housing part 3. Overall, the manner of the connection of ring 21 to shaft 7, and the connection of outer ring 22 to housing part 3, keeps deformation of roller bearing 5 caused by installation to a minimum, in such a manner that the configuration reliably rules out significant changes in bearing parameters, particularly radial bearing play, even at industrial mass production scales.

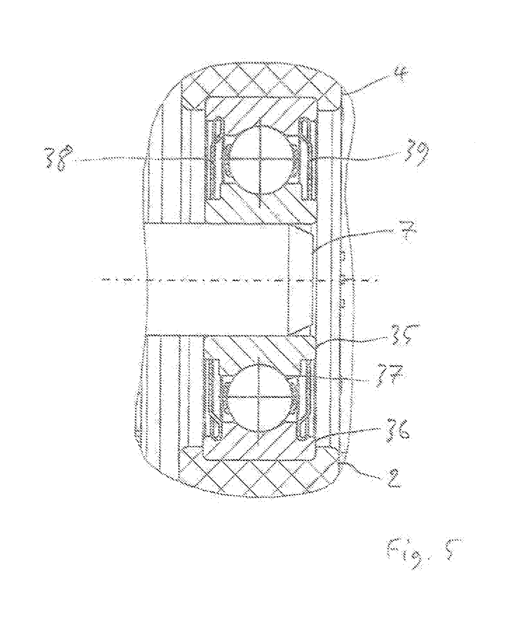

FIG. 5 shows the arrangement of roller bearing 6, functioning as a floating bearing, in housing 2 in detail. Similarly to roller bearing 5, roller bearing 6 also has inner ring 35, outer ring 36, and balls as rolling elements 37. In contrast to roller bearing 5, roller bearing 6 is sealed on both ends thereof by seal 38, 39. No force fit occurs between inner ring 35 and shaft 7, such that at least a minimal axial displacement—particularly caused by temperature—between shaft 7 and roller bearing 6 is possible at this position. Outer ring 36 is injected into housing part 4 made of plastic. As such, bearing ring 36 is secured in housing part 4 against both axial displacement and rotation.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMBERS

1 electric motor

2 housing

3 metallic housing part

4 housing part made of plastic

5 first roller bearing

6 second roller bearing

7 shaft

8 drive element

9 seal

10 shaft seal ring

11 rotor

12 permanent magnet

13 stator winding

14 stator lamination

15 plug

16 circuit board

17 cover

18 magnetic field sensor

19 temperature sensor

20 housing flange

21 inner ring

22 outer ring

23 rolling element

24 cage

25 contact surface

26 waist

27 first section

28 second section

29 running surface

30 receiver section

31 wall

32 shoulder

33 sleeve section

34 arresting point

35 inner ring

36 outer ring

37 rolling element

38 seal

39 seal

S1 first end face

S2 second end face

1. A bearing arrangement in an actuating motor of an electrical camshaft adjuster, comprising:
a first, bowl-shaped housing part made of metal;
a second housing part made of plastic, closing off the first housing part;
a first roller bearing which is held in a first housing part;
a second roller bearing which is inserted into the second housing part; and,
a shaft mounted by means of the roller bearings, wherein:
one of the first or second roller bearings is designed as a fixed bearing;
a contact surface which transmits force, and which is smaller than the inner running surface of an inner ring, is formed between the shaft and an inner ring of the first roller bearing;
the first roller bearing is designed as an open bearing which is lubricated by an operating medium; and,
the second roller bearing is designed as a sealed bearing with a lifetime supply of grease.

2. The bearing arrangement according to claim 1, wherein a waist of the shaft adjoins the contact surface.

3. The bearing arrangement according to claim 2, wherein the waist is arranged axially between a first section and a second section of the contact surface.

4. The bearing arrangement according to claim 1, wherein the contact surface is formed by at least one bar positioned on the shaft, contacting the inner ring and integrated as a single piece with the shaft.

5. The bearing arrangement according to claim 1, wherein the first roller bearing is designed as a fixed bearing.

6. The bearing arrangement according to claim 5, wherein the first roller bearing has an outer ring which is inserted into a receiver section of the first housing part, said receiver section being the inner boundary of an end-face wall of the first housing part.

7. The bearing arrangement according to claim 6, wherein the receiver section has a conical or polygonal shape, or is stepped.

8. The bearing arrangement according to claim 6, wherein the outer ring is arrested in the receiver section of the first housing part.

9. The bearing arrangement according to claim 1, wherein the second roller bearing is designed as a fixed bearing.

10. The bearing arrangement according to claim 1, wherein a shaft seal is positioned on a side of the first roller bearing, which faces an internal space of the housing of the electric motor.
